(19) United States
(12) Patent Application Publication
(10) Pub. No.: US 2021/0192304 A1
(43) Pub. Date: Jun. 24, 2021

(54) POWER SUPPLY MANAGEMENT METHOD

(71) Applicants: STMicroelectronics (Rousset) SAS, Rousset (FR); STMicroelectronics (Alps) SAS, Grenoble (FR)

(72) Inventors: Julien MERCIER, Mimet (FR); Pascal NONIER, Saint-Ismier (FR)

(73) Assignees: STMicroelectronics (Rousset) SAS, Rousset (FR); STMicroelectronics (Alps) SAS, Grenoble (FR)

(21) Appl. No.: 17/126,830

(22) Filed: Dec. 18, 2020

(30) Foreign Application Priority Data
Dec. 19, 2019 (FR) 1914965

(51) Int. Cl. G06K 19/07

(52) U.S. Cl. CPC G06K 19/0712; G06K 19/0715; G06K 19/0708; G06K 19/0723; G06K 19/0718

(57) ABSTRACT

A method of managing the power supply of one or more first elements by a second element of a same first device, includes the steps of: sending, to a second device, a time extension request; evaluating during the time extension a power available from an electromagnetic field radiated by the second device; and adjusting the power supply of the second element and of the first element(s) according to the available power.

### PRIORITY CLAIM

This application claims the priority benefit of French Application for Patent No. 1914965, filed on Dec. 19, 2019, the content of which is hereby incorporated by reference in its entirety to the maximum extent allowable by law.

### TECHNICAL FIELD

The present disclosure generally relates to electronic devices and, more specifically, to cards powered by an external electromagnetic field.

### BACKGROUND

There are many applications where an electronic device comprises no internal power supply, so that circuits embarked on this device can only be activated when a sufficient power is supplied thereto, externally, by another device. This is particularly true for certain contactless cards which draw, generally from an electromagnetic field emitted by a reader located within their range, the electric power necessary to power their circuits. Such circuits may have a limited electric power which should be managed at best to guarantee an optimal operation of the device to which they belong.

There is a need to improve methods for managing the power supply of electronic devices comprising no internal power supply.

There is a need to overcome all or part of the disadvantages of known power supply management methods.

### SUMMARY

An embodiment provides a method of management of the power supply of one or first elements by a second element of a same first device, comprising the steps of: sending, to a second device, a time extension request; evaluating, during the time extension, a power available from an electromagnetic field radiated by the second device; and adjusting the power supply of the second element and of the first element(s) according to the available power.

According to an embodiment, the second element is remotely supplied via the electromagnetic field.

According to an embodiment, the second element is a secure electronic circuit.

According to an embodiment, the second element executes the steps of sending the time extension request, of evaluating the power, and of adjusting the power supply.

According to an embodiment, the first device comprises exactly two first elements, the first elements preferably being a microcontroller and a fingerprint sensor.

According to an embodiment: the first device is a card, preferably a contactless payment card; and the second device is a reader, preferably a contactless payment terminal.

According to an embodiment, the first element(s) are powered with a voltage in the range from 1 V to 5.5 V.

According to an embodiment, the second element comprises a component configured to evaluate a current available from the electromagnetic field radiated by the second device.

According to an embodiment, the second element comprises a switch configured to cut off the power supply of the first element(s).

According to an embodiment, the switch is driven by a voltage regulator activated according to a state of the current evaluation component.

According to an embodiment, the first element(s) are powered: by a capacitor when the switch is off; and by the voltage regulator when the switch is on.

According to an embodiment, the second element turns off the switch in case of an excessive power consumption of the second element(s).

According to an embodiment, the second element is set to a low power consumption mode during the evaluation of the available power.

According to an embodiment, the available power is evaluated after other time extensions, the power supply of the first element(s) being adjusted according to each evaluation of the available power.

According to an embodiment, when the first element(s) are powered, the second element adjusts an operating frequency of the second element and an operating frequency of the first element(s) according to the available power.

An embodiment provides a secure electronic circuit configured to implement the method such as described.

An embodiment provides a contactless electronic card comprising at least one circuit such as described.

### BRIEF DESCRIPTION OF THE DRAWINGS

The foregoing and other features and advantages of the present invention will be discussed in detail in the following non-limiting description of specific embodiments and implementation modes in connection with the accompanying drawings, in which:

FIG. 1 very schematically shows in the form of blocks an example of a near-field communication system of the type to which the described embodiments apply as an example;

FIG. 2 is a timing diagram of an example of a radiofrequency communication;

FIG. 3 is a timing diagram of another example of a radiofrequency communication;

FIG. 4 schematically shows in the form of blocks an example of a card;

FIG. 5 is a timing diagram of an example of the state variation of an element of the card of FIG. 4 during a radio frequency communication with a reader;

FIG. 6 very schematically shows in the form of blocks an embodiment of a card;

FIG. 7 is a timing diagram of an implementation mode of a method of managing the power supply of the card of FIG. 6;

FIG. 8 schematically shows in the form of blocks an embodiment of a power supply architecture of the card of FIG. 6;

FIG. 9 is another timing diagram of the power supply management method of FIG. 7 according to an embodiment; and

FIG. 10 is still another timing diagram of the power supply management method of FIG. 7 according to an embodiment.

### DETAILED DESCRIPTION

Like features have been designated by like references in the various figures. In particular, the structural and/or functional elements common to the different embodiments and implementation modes may be designated with the same reference numerals and may have identical structural, dimensional, and material properties.

For clarity, only those steps and elements which are useful to the understanding of the described embodiments and implementation modes have been shown and will be detailed. In particular, the commands which are executed are not detailed, the described embodiments and implementation modes being compatible with usual commands executed by contactless cards.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., unless otherwise specified, it is referred to the orientation of the drawings.

Unless specified otherwise, the expressions “around”, “approximately”, “substantially” and “in the order of” signify within 10%, and preferably within 5%.

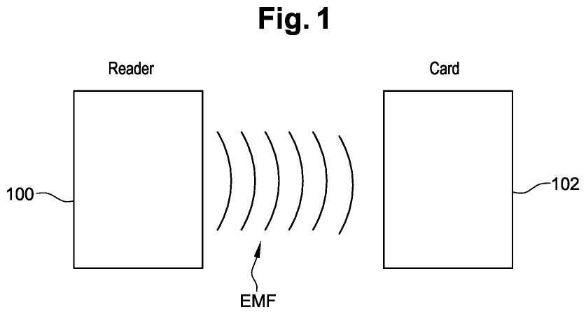

FIG. 1 very schematically shows, in the form of blocks, an example of a near-field communication system of the type to which the embodiments which will be described apply as an example.

In the example of FIG. 1, a first device or reader 100 (Reader), for example, a payment terminal, a cell phone, a readout terminal, etc., radiates a radiofrequency electromagnetic field EMF captured by a second device or card 102 (Card), for example, a contactless payment card, a personal access card, a transport card, etc.

In the case of a radio frequency communication, reader 100 detects the presence of card 102 in its EMF field, and then starts a communication procedure comprising exchanges of requests by reader 100 and of answers by card 102. Such a communication, be it performed in the field of bank transactions, of identification, of transports, of access management, etc., is generally based on the ISO 14443 standard, for example, in its 2018 version, and implements standardized protocols of exchange between reader 100 and the card 102 located within its range.

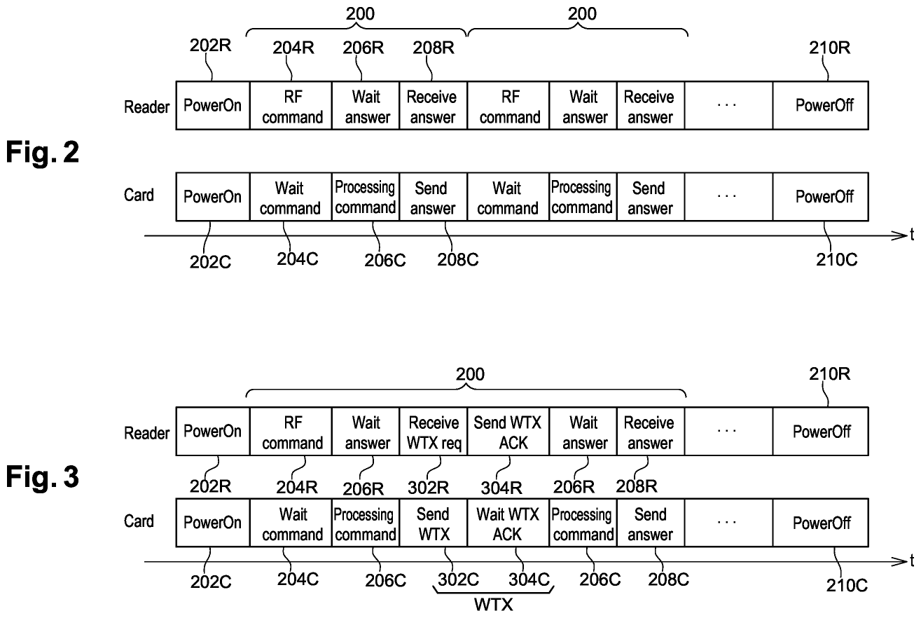

FIG. 2 is a timing diagram of an example of a radio frequency communication between the reader 100 (Reader) and the card 102 (Card) 102 of FIG. 1.

After a powering-on 202R, 202C (PowerOn) of reader 100 and of card 102, reader 100 starts a communication phase 200 by sending 204R (RF command) a radiofrequency command (RF) to card 102, which is waiting 204C (Wait command) for the reception of a command. Then, card 102 executes 206C (Processing command) the command, reader 100 waiting 206R (Wait answer) for a response from card 102. Once the command has been executed, card 102 sends 208C (Send answer) an answer to reader 100, which receives 208R (Receive answer) this answer. This ends communication phase 200. One or a plurality of other communication phases 200 may then take place before a powering-off 210R, 201C (PowerOff) of reader 100 and of card 102.

Generally, reader 100 assigns to card 102 a maximum duration, for example, 38 ms, for the execution 206C of each command. It is, however, generally provided for card 102 to sometimes ask reader 100 to grant it a time extension WTX (Wait Time eXtension), in other words an additional delay, as discussed hereafter in relation with FIG. 3.

FIG. 3 is a timing diagram of another example of a radio frequency communication between the reader 100 (Reader) and the card 102 (Card) of FIG. 1. The timing diagram of FIG. 3 comprises elements common with the timing diagram of FIG. 2. The common elements will not be described again hereafter.

In the timing diagram of FIG. 3, as compared with the timing diagram of FIG. 2, the phase of execution 206C (Processing command) of the command by card 102 is extended. Such an extension, on the initiative of card 102, results from a sending 302C (Send WTX) of a request for a time extension WTX to reader 100, which receives 302R (Receive WTX req) the request. As a response, reader 100 sends 304R (Send WTX ACK) an acknowledgement ACK to card 102, which waits 304C (Wait WTX ACK) for acknowledgement ACK. Card 102 carries on the execution 206C of the command, reader 100 waiting 206R (Wait answer) for the answer of card 102.

On execution 206C of a same command by card 102, a plurality of time extensions WTX, comprising operations 302C, 302R, 304C, and 304R, may be successively granted by reader 102. Further, each communication between reader 100 and card 102 may comprise any number of communication phases 200, with or without time extension WTX, before the powering-off 210R, 210C (PowerOff) of reader 100 and of card 102.

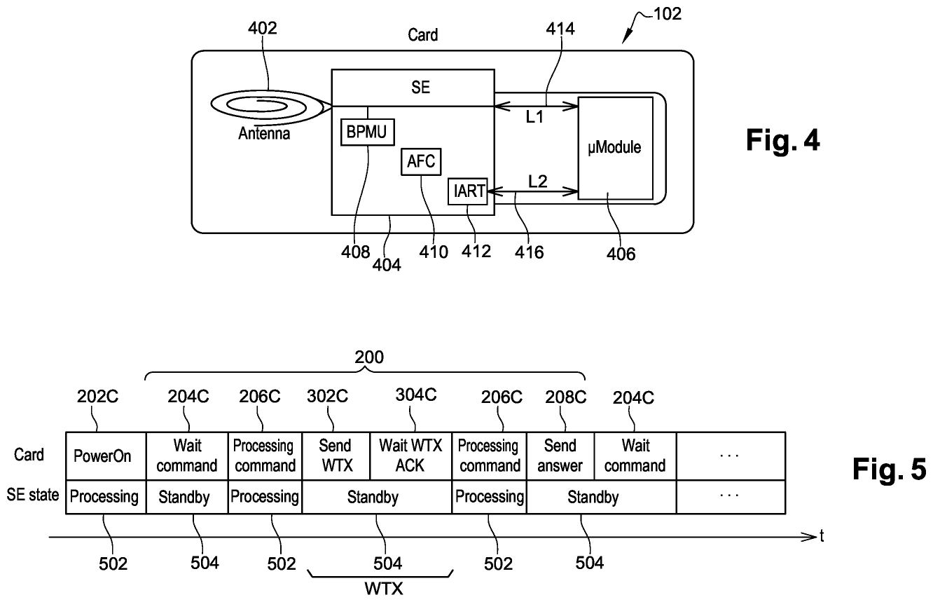

FIG. 4 schematically shows in the form of blocks an example of a card 102 (Card) comprising: a near-field communication antenna 402 (Antenna); a first secure element 404 (SE), for example, a secure circuit or microcontroller; and an electronic processing module 406 (μModule).

First secure element 404 comprises: a power management macrocell or unit 408 (BPMU) according to power supply needs of the first secure element of card 102; another frequency adjustment macrocell or unit 410 (AFC) enabling to adjust, according to the EMF field (FIG. 1), an operating frequency of the first secure element of card 102; and still another communication macrocell or unit 412 (TART), for example, an asynchronous receiver transmitter.

Electronic processing module 406 is coupled or connected: to first secure element 404 over a connection 414 (L1) conveying a power supply voltage for example in the range from 1 V to 5.5 V; and to communication macrocell 412 over another connection 416 (L2) in accordance, for example, with the requirements of the 2013 ISO 7816 standard and used for contact communications.

During a contactless communication of the type of those discussed in relation with FIGS. 2 and 3, card 102 is particularly capable of managing: the operating frequency of first secure element, due to frequency adjustment macrocell 410, which adjusts this frequency according to an energy available from the EMF field (FIG. 1); the power supply voltage of first secure element, due to power management macrocell 408, which adjusts the power supply voltage according to the power supply needs of first secure element; and a plurality of power supply modes, for example, a nominal mode, a low power consumption mode, etc.

During operations 204C, 208C, 302C, 304C (FIG. 3) comprising receiving or sending data, for example, commands, answers, time extension requests WTX, etc., between reader 100 and card 102, the EMF radiofrequency field (FIG. 1) is modulated. The first secure element of card 102 is set to the low power consumption mode, or standby mode, during these operations, that is, outside of the operations of execution 206C of a command and of powering-on 202C. During the operations of execution 206C of a command and of powering-on 202C, first secure element is in nominal mode. Due to interoperability constraints, it is generally made sure that card 102, particularly first secure element, does not cause noise or electronic disturbances during operations 204C, 208C, 302C, 304C (FIG. 3) comprising exchanging information with reader 100.

FIG. 5 is a timing diagram of an example of state variation (SE state) of the first secure element 404 of the card 102 (Card) of FIG. 4 during a radio frequency communication with reader 100 (FIG. 1).

In this example, first secure element is set: to the nominal power supply mode 502 (Processing), during the powering-on 202C (PowerOn) of card 102 and during operations of execution 206C (Processing command) of commands; and to the low power consumption mode 504 (Standby) the rest of the time, in other words, during the operations of: waiting 204C for a command (Wait command); time extension (WTX), in other words, sending 302C of a time extension request (Send WTX) and then waiting 304C for an acknowledgement ACK (Wait WTX ACK) confirming that reader 100 grants time extension WTX; and sending 208C of an answer (Send answer).

First secure element manages its power supply needs each time it is switched from or to the low power consumption mode 504. In particular: at each switching to the low power consumption mode 504, frequency adjustment macrocell 410 (FIG. 4) is deactivated and power management macrocell 408 (FIG. 4) adjusts or regulates the power supply voltage so that it corresponds to low power consumption mode 504; and at each switching to the nominal mode 502, frequency adjustment macrocell 410 is activated and power management macrocell 408 adjusts or regulates the power supply voltage so that it corresponds to nominal mode 502.

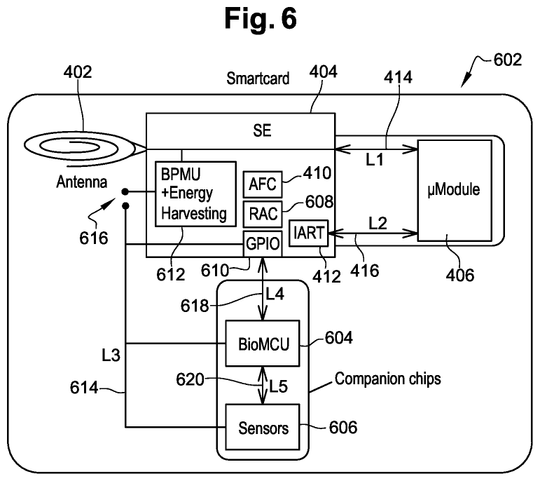

FIG. 6 schematically shows in the form of blocks an embodiment of a card 602 (Smartcard), for example, a contactless payment card, an identity card, a transport card, a personal access card, etc.

Card 602 is particularly configured to communicate with a reader, preferably a payment terminal, for example, the reader 100 of FIG. 1. The card 602 of FIG. 6 comprises elements common with the card 102 of FIG. 4. These common elements will not be described again hereafter.

As compared with the card 102 of FIG. 4, the card 602 of FIG. 6 particularly comprises one or a plurality of second additional elements (Companion chips). Card 602 preferably comprises two second elements: a second element or microcontroller 604 (BioMCU); and another second element or sensor 606 (Sensors) preferably corresponding to a biometric sensor, more preferably a fingerprint sensor.

It is said that the second elements 604 and 606 form together a “biometric environment”, card 602 being then called a biometric card.

As compared with the first secure element of FIG. 4, the first secure element (SE) of FIG. 6 comprises: an available current macrocell or unit 608 (RAC) for evaluating the current available from the EMF electromagnetic field (FIG. 1); and input-output terminals 610 (GPIO), preferably universal (General Purpose Input-Output).

The first secure element of card 602 is remotely supplied via the EMF field radiated by reader 100 (FIG. 1).

In the first secure element of FIG. 6, power management macrocell 408 (FIG. 4) is replaced with a management and energy harvesting macrocell or unit 612 (BPMU+Energy Harvesting) combining functionalities similar to those of the power management macrocell 408 of FIG. 4 and additional energy harvesting and/or distribution functionalities.

Each second element 604, 606 is coupled, preferably connected, to the management and energy harvesting macrocell 612 of first secure element by a connection 614 (L3) preferably conveying a power supply voltage in the range from 1 V to 5.5 V. A switch 616 placed downstream of management and energy harvesting macrocell 612 is configured to establish or cut off the power supply of second elements 604 and 606. Although switch 616 is shown in FIG. 6 as not belonging to management and energy harvesting macrocell 612, switch 616 may in practice be integrated to management and energy harvesting macrocell 612. In other words, switch 616 is, in FIG. 6, functionally shown.

Microcontroller 604 is coupled, preferably connected, to the general purpose input-output terminals 610 of first secure element by another connection 618 (L4). Connection 618 conveys, preferably, one or a plurality of communication and/or power supply signals between first secure element and microcontroller 604.

Fingerprint sensor 606 is coupled, preferably connected, to microcontroller 604 by still another connection 620 (L5). Link 620 for example enables sensor 606 to send to microcontroller 604 data representative of a fingerprint acquired in the form of an image by sensor 606.

The presence, in card 602, of second elements 604 and 606 complicates the power management with respect to the card 102 of FIG. 4. Indeed, biometric card 602 is configured to manage not only the energy needs of first secure element, but also those of second elements 604 and 606. Biometric card 602 thus manages the energy needs of three elements, in the case in point first secure element and the two second elements 604 and 606, while card 102 manages the energy needs of a single element, in the case in point first secure element.

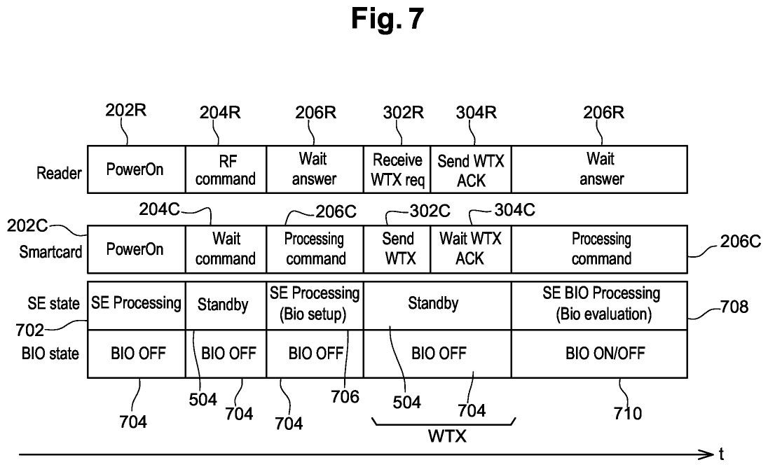

FIG. 7 is a timing diagram of an implementation mode of a method of managing the biometric card 602 (Smartcard) of FIG. 6 during a communication with reader 100 (Reader) of FIG. 1. The timing diagram of FIG. 7 comprises elements common with the timing diagram of FIG. 5. These common elements will not be described again hereafter. In the timing diagram of FIG. 7, a line (BIO state) symbolizes a variation of a state of the biometric environment formed by second elements 604, 606 (FIG. 6).

According to this embodiment, it is made sure that a communication or transaction using biometric environment 604, 606 (FIG. 6) is perceived, by reader 100 (FIG. 1), as being identical to a standard communication or transaction, for example, such as that discussed in relation with FIG. 3. This provides an advantageous backward compatibility of card 602 (FIG. 6) with the existing readers 100.

Biometric card 602 is configured to evaluate the power supply available from the EMF field emitted by reader 100. According to this evaluation, advantageously managed transparently for reader 100, card 602 chooses whether to power or not the second elements 604 and 606. The evaluation of the power supply available from the EMF field emitted by reader 100 is preferably performed during a period when first secure element is set to the low power consumption mode 504 (Standby). A more accurate evaluation of the available power supply is thus obtained.

At the powering-on 202R, 202C of reader 100 and of card 602, first secure element is in an active state 702 (SE Processing), or nominal mode, of first secure element, similar to the state 502 of the timing diagram of FIG. 5. The biometric environment 604, 606 then is powered off 704 (BIO OFF) and is held in the powered-off state 704 until further notice. During the waiting 204C (Wait command) for the sending 204R (RF command) of a command, first secure element is in low power consumption mode 504 (Standby).

According to a preferred implementation mode, first secure element triggers the sending 302C (Send WTX) of a time extension request WTX during the execution 206C (Processing command) of a command. This causes the switching of first secure element to the low power consumption mode 504. First secure element takes advantage of such a switching to the low power consumption mode 504 to evaluate the power supply available from the EMF field.

Before the sending 302C of time extension request WTX, first secure element is in a state 706 (SE Processing (Bio setup)) of configuration of the biometric environment where it: determines a value of the power supply voltage of second elements 604 and 606 and configures management and energy harvesting macrocell 612 (FIG. 6) so that it delivers, as soon as it is come out of the low power consumption mode 504 after the time extension request WTX, a power supply voltage equal to this value; evaluates, via available current macrocell 608, the current potentially available from the EMF field to power elements 404, 604, and 606 and particularly decides, according to the evaluation, whether to power or not (state 710, BIO ON/OFF) second elements 604, 606 as soon as it is come out of the low power consumption mode 594 after time extension request WTX; and deactivates frequency adjustment macrocell 410 as soon as it is come out of low power consumption mode 504 after time extension request WTX, due to the fact that the power consumption of second elements 604 and 606 is not predictable.

At the coming out of low power consumption mode 504, after time extension request WTX, the first secure element of card 602 switches to another state 708 (SE BIO Processing (Bio evaluation)) of evaluation of the available power, where: second elements 604 and 606 are powered if the state of available current macrocell 608 is compatible with the energy needs of second elements 604 and 606; and frequency adjustment macrocell 410 is deactivated.

In a case where the available power is sufficient to power second elements 604 and 606, second elements 604 and 606 are then powered on. According to an embodiment, when second elements 604 and 606 are powered, first secure element adjusts the operating frequency of first secure element and/or the operating frequency of second elements 604 and 606 according to the available power.

It could have been devised to activate second elements 604 and 606 and to manage their energy needs while first secure element is in nominal mode 702. However, this would be less reliable and more complex to achieve than when first secure element is in low power consumption mode 504.

It could also have been devised to attempt activating second elements 604, 606 as soon as the powering on 202C of card 602. However, if the available power is insufficient at the powering on 202C, card 602 risks being inoperative, which tends to degrade the user experience.

Before card 602 answers reader 100, first secure element is switched back to the nominal mode 702 due to another time extension request WTX.

The described embodiment allows a good reliability of radio frequency communications through: a power supply architecture enabling to manage radio frequency noise, isolated from the power supply of second elements 604, 606, and an evaluation of the radio frequency field by the dedicated available current macrocell 608; a management of the power supply, supplied externally, during time extension requests WTX during which second elements 604, 606 are powered; and a preservation of the exchanges between first secure element and reader 100 even when second elements 604, 606 are powered.

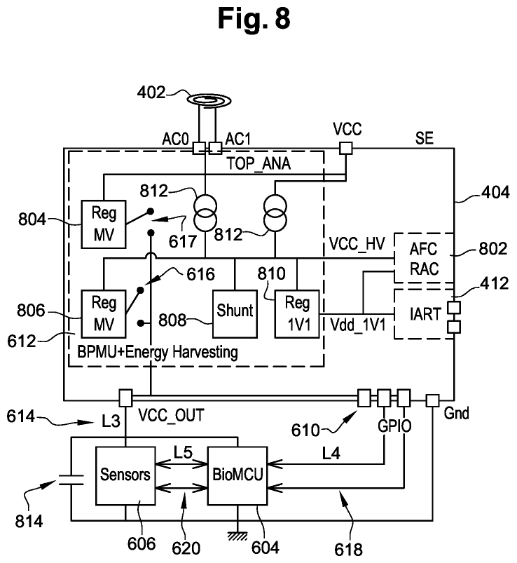

FIG. 8 schematically shows in the form of blocks an embodiment of a power supply architecture of the card 602 of FIG. 6.

According to this embodiment, first secure element (SE) comprises: a block 802 (AFC RAC) schematizing the macrocells 410 and 608 of FIG. 6; a voltage regulator 804 (Reg MV) for the contact power supply of first secure element and of second elements 604 (BioMCU) and 606 (Sensors) from a terminal of application of a potential noted VCC via a connection (TOP_ANA); and another voltage regulator 806 (Reg MV) for the contactless power supply, from antenna 402 connected to terminals (AC0, AC1), of second elements 604 and 606.

According to an embodiment, voltage regulators 804, 806 form part of management and energy harvesting macrocell 612 (BPMU+Energy Harvesting) which further comprises: a block 808 (Shunt) configured to mask possible electronic disturbances, originating from first secure element and/or second elements 604 and 606 in their different operating modes, capable of propagating to antenna 402; still another voltage regulator 810 (Reg 1V1) powered from block 802 and communication macrocell 412 (TART) by a voltage noted Vdd_1V1; and transformers 812 coupled, preferably connected, to a bus conveying a power supply voltage (VCC_HV).

By default, second elements 604 and 606 are not powered. Voltage regulator 806 drives switch 616 configured to establish or cut off the power supply of second elements 604 and 606 when card 602 (FIG. 6) is near-field powered. Regulator 806 is activated according to the state of current evaluation component 802. In the case of a contact communication, voltage regulator 804 drives another switch 617 configured to establish or cut off the power supply of second elements 604 and 606.

The power supply of second elements 604 and 606 is preferably controlled by software according to the state of macrocell 802. A capacitor 814 is connected in parallel with second elements 604 and 606. At the coming out of standby mode 504 (FIG. 7), voltage VCC_HV is adjusted by block 802 according to the power supply needs of second elements 604 and 606.

First elements 604, 606 are powered: by capacitor 814, when switches 616 and 617 are turned off; by voltage regulator 806, when switch 616 is turned on in the context of a contactless power supply; or by voltage regulator 804, when switch 617 is turned on in the context of a contact power supply.

In FIG. 8, the second elements 604 and 606 are powered under a voltage, noted VCC_VOUT, in the range from 1 V to 5.5 V. Second element 604 is coupled, preferably connected, to universal input-output terminals 610 (GPIO). Second elements 604, 606 are both coupled, preferably connected, to a terminal of application of a reference potential, for example, the ground (Gnd).

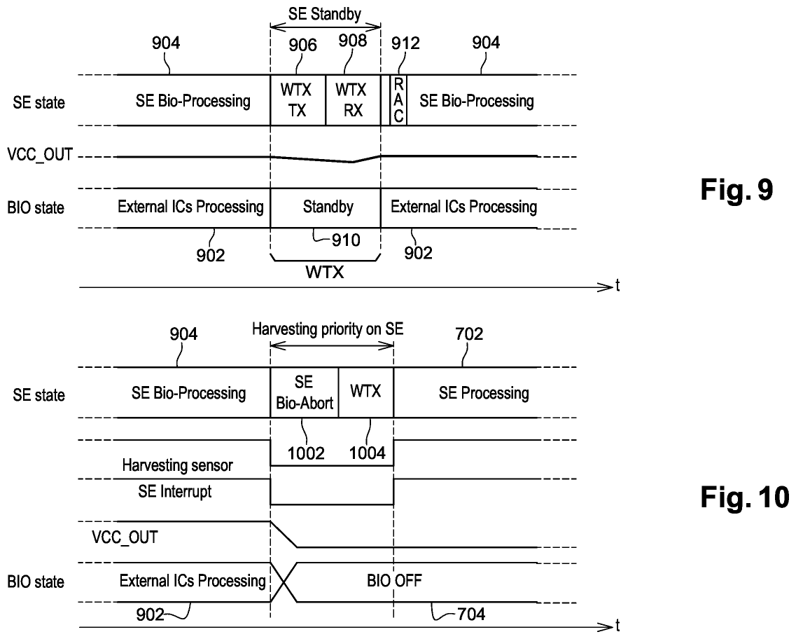

FIG. 9 is another timing diagram of the power supply management method of FIG. 7 according to an embodiment. FIG. 9 more particularly shows a variation: of the state (SE state) of first secure element (FIG. 8); of the power supply voltage VCC_OUT of second elements 604 and 606 (FIG. 8); and of the state (BIO state) of the biometric environment, that is, of second elements 604 and 606.

According to this implementation mode, second elements 604 and 606 are initially powered 902 (External ICs Processing) and first secure element is in a state 904 (SE Bio-Processing) where it executes biometric processing operations. It is then assumed that first element SE sends 906 (WTX TX) a time extension request to reader 100 (FIG. 1), and then receives 908 (WTX RX) a confirmation indicating that the request has been granted. During operations 906 and 908 of time extension request WTX: first secure element (FIG. 8) is set to the low power consumption mode (SE Standby); and second elements 604 and 606 (FIG. 8) are set to the low power consumption mode 910 (Standby).

Second elements 604 and 606 are then preferably not powered from voltage regulator 806 (FIG. 8). For example, the switch 616 driven by voltage regulator 806 is turned off. While they are in low power consumption mode 910, second elements 604 and 606 are powered, preferably by capacitor 814 (FIG. 8).

After time extension request WTX, first secure element (FIG. 8) re-evaluates 912 (RAC), via block 802, the current available from the field to power second elements 604 and 606. According to the evaluation performed by block 802, for example if the available current is sufficient, card 602 may decide to carry on the execution of biometric operations. In this case: first secure element is set back to state 904 (SE Bio-Processing); and second elements 604 and 606 are powered 902 (External ICs Processing).

In the opposite case, card 602 may decide to interrupt the execution of the biometric operations, for example, by cutting off the power supply 902 of second elements 604 and 606.

In other words, first secure element: sends, to reader 100 (FIG. 1), a time extension request WTX; evaluates, during time extension WRX, a power available from the electromagnetic field EMF radiated by reader 100; and adjusts its power supply and the power supply of second elements 604, 606 according to the available power.

According to a preferred embodiment, the available power is evaluated after other time extensions, for example, similar to the above-described time extension WTX, the power supply of first element(s) 604, 606 being adjusted according to each evaluation of the available power.

FIG. 10 is still another timing diagram of the power supply management method of FIG. 7 according to an implementation mode.

FIG. 10 more particularly shows a variation: of the state (SE state) of first secure element (FIG. 8); of a signal (Harvesting sensor) of a sensor, for example, a sensor of voltage VCC_OUT which triggers in case of a crossing of a high threshold beyond which it is considered that the energy consumed by second elements 604 and 606 is too high; of another signal (SE Interrupt) of interruption of first secure element; of the power supply voltage VCC_OUT of second elements 604 and 606 (FIG. 8); and of the state (BIO state) of the biometric environment, that is, of second elements 604 and 606.

According to this embodiment, available current macrocell 608 (FIG. 6) evaluates a generally power supply capacity, that is, for all the elements 404, 604, 606 of card 602. Such a power supply capacity is then distributed between first secure element and second elements 604 and 606 according to a maximum power consumption of each element.

In case, for example, of a degradation of the fingerprint sensor 606 of card 602 (FIG. 6) or of leakages at the level of the connection pads of microcontroller 604, this may result in an excessive or unexpected power consumption of sensor 606 or of microcontroller 604, respectively. In this case, first secure element is advantageously configured to cut off the power supply of second elements 604 and 606.

According to this embodiment, second elements 604 and 606 are initially in state 902 (External ICs Processing) and first secure element is in state 904 (SE Bio-Processing). It is then assumed that it is desired to cut off the power supply of second elements 604, 606. The first element then transmits a command 1002 (SE Bio-Abort) for powering off second elements 604 and 606 and then a time extension request 1004 (WTX). The execution of command 1002 results in the powering off 704 (BIO OFF) of the second elements 604, 606. This is particularly reflected by the fact that signal VCC_OUT is, after the discharge of capacitor 814 (FIG. 8), equal to approximately 0 V.

According to this embodiment, it is then switched from state 904, where first secure element and second elements 604, 606 are powered, to state 702 (SE Processing), where only first secure element is powered. The time extension request 1004 here enables to make sure that the communication between card 602 and reader 100 remains active and first secure element switches back to state 702.

In other words, card 602 is configured to give a power supply harvesting priority (Harvesting priority on SE) to first secure element.

The component 608 of the first secure element of card 602 (FIG. 6) is thus configured to evaluate the current available from the EMF field radiated by reader 100 (FIG. 1). The power supply of first secure element and of second elements 604, 606 is then adjusted according to the evaluation of the current. The adjustment is preferably performed: either by the cutting off of the power supply of second elements 604 and 606, if the available current is not sufficient to properly power second elements 604 and 606 while keeping an operational communication between first secure element and reader 100; or by adjustment of the power supply of first secure element and of second elements 604, 606 according to the power supply needs of each element.

The above-described embodiments have the advantage of being compatible with current protocols of communication between a card 602 (FIG. 6) and a reader 100 (FIG. 1). The power supply of second elements 604 and 606 is in particular managed by card 602 transparently for reader 100. Thus, in the case of card 602, first secure element manages additional elements 604, 606 with respect to card 102 (FIG. 4). However, reader 100 may indifferently communicate with card 102 or with card 602 without for this to cause a modification in terms of communication protocol. The existing readers 100 can thus be kept, to communicate with card 602.

Various embodiments, implementation modes, and variations have been described. Those skilled in the art will understand that certain features of these various embodiments, implementation modes, and variants, may be combined and other variants will occur to those skilled in the art.

Finally, the practical implementation of the described embodiments, implementation modes, and variants is within the abilities of those skilled in the art based on the functional indications given hereabove.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method of power supply management of one or a plurality of first elements by a second element of a same first device, comprising the steps of:
sending by the second element of the first device of a time extension request to a second device;
evaluating by the second element of the first device of a power available from an electromagnetic field radiated by the second device during a time extension provided in connection with the time extension request;
adjusting power supply of the second element according to the available power; and
adjusting power supply of the first element(s) according to the available power.

2. The method according to claim 1, wherein the second element is remotely supplied via the electromagnetic field.

3. The method according to claim 1, wherein the second element is a secure electronic circuit.

4. The method according to claim 1, wherein the second element carries out the steps of adjusting the power supply.

5. The method according to claim 1, wherein the first device comprises exactly two first elements, the first elements preferably being a microcontroller and a fingerprint sensor.

6. The method according to claim 1, wherein:
the first device is a card, preferably a contactless payment card; and
the second device is a reader, preferably a contactless payment terminal.

7. The method according to claim 1, wherein the first element(s) are powered with a voltage in the range from 1 V to 5.5 V.

8. The method according to claim 1, further comprising evaluating, by the second element, a current available from the electromagnetic field radiated by the second device.

9. The method according to claim 8, wherein adjusting comprises using a switch of the second element to cut off the power supply of the first element(s).

10. The method according to claim 9, further comprising driving the switch by a voltage regulator activated according to a state of the current available.

11. The method according to claim 10, wherein the first element(s) are powered:
by a capacitor when the switch is off; and
by the voltage regulator when the switch is on.

12. The method according to claim 9, further comprising turning off the switch, by the second element, in case of an excessive power consumption of the second element.

13. The method according to claim 1, further comprising setting the second element to the low power consumption mode during the evaluation of the available power.

14. The method according to claim 1, wherein the available power is evaluated after other time extensions, further comprising adjusting the power supply of the first element(s) according to each evaluation of the available power.

15. The method according to claim 1, further comprising, when the first element(s) are powered, adjusting by the second element of an operating frequency of the second element according to the available power and adjusting an operating frequency of the first element(s) according to the available power.

16. A secure electronic circuit configured to implement the method according to claim 1.

17. A contactless electronic card comprising at least one circuit according to claim 16.
